(19) United States
(12) Patent Application Publication
(10) Pub. No.: US 2019/0217423 A1
(43) Pub. Date: Jul. 18, 2019

(54) FLUX-CORED WIRE FOR GAS SHIELDED ARC WELDING

(71) Applicant: NIPPON STEEL AND SUMIKIN WELDING CO., LTD., Tokyo (JP)

(72) Inventors: Naoki SAKABAYASHI, Tokyo (JP); Kiyohito SASAKI, Tokyo (JP); Ryutaro CHIBA, Tokyo (JP)

(73) Assignee: NIPPON STEEL AND SUMIKIN WELDING CO., LTD., Tokyo (JP)

(21) Appl. No.: 16/248,457

(22) Filed: Jan. 15, 2019

(30) Foreign Application Priority Data
Jan. 16, 2018 (JP) 2018-005216
Oct. 10, 2018 (JP) 2018-192082

(51) Int. Cl. B23K 35/30; B23K 35/02; C22C 38/06; C22C 38/04; C22C 38/02; C22C 38/00

(52) U.S. Cl. CPC B23K 35/3073; B23K 35/0266; C22C 38/002; C22C 38/04; C22C 38/02; C22C 38/06

(57) ABSTRACT

A flux-cored wire includes by mass %: C in a skin of 0.04 to 0.08% w.r.t. a total mass of the skin, w.r.t. a total mass of the wire by a sum of the skin and flux: C: 0.05 to 0.12%, Si: 0.1 to 0.6%, Mn: 1.5 to 3.5%, B: 0.002 to 0.015%, a sum of Al₂O₃ conversion value of Al and Al₂O₃ conversion value of an Al oxide: 0.3 to 1.5%, and w.r.t. the total mass of the wire in the flux: Mg: 0.2 to 0.8%, and sums of TiO₂ conversion value of a Ti oxide: 5 to 10%, SiO₂ conversion value of a Si oxide: 0.2 to 0.7%, ZrO₂ conversion value of a Zr oxide: 0.1 to 0.6%, F conversion value of a fluorine compound: 0.02 to 0.15%, and Na₂O conversion value and a K₂O conversion value of a Na compound and a K compound: 0.03 to 0.20%.

### BACKGROUND

### 1. Technical Field

The present invention relates to a flux-cored wire for gas shielded arc welding used for welding of a steel structure such as a 490 MPa class high-tensile steel and a low-temperature steel from a mild steel, and especially relates to a flux-cored wire for gas shielded arc welding preferred to obtain a weld metal featuring good welding workability in welding at all positions, a small amount of generated spatter, and excellent low-temperature toughness.

### 2. Related Art

Since a flux-cored wire for gas shielded arc welding features high efficiency and excellent welding workability, the flux-cored wire for gas shielded arc welding has been widely used for a construction of various welded structures such as a shipbuilding, a bridge, a marine structure, and a steel frame. Especially, a rutile-based flux-cored wire is considerably excellent in welding workability in welding at all positions and therefore has been widely used mainly in a field such as the shipbuilding, the steel frame, and the marine structure.

However, since the rutile-based flux-cored wire contains a large amount of metal oxide, mainly TiO₂, the welding under a low temperature environment has caused a problem of inferiority in low-temperature toughness of a weld metal.

Various developments have been conducted on the rutile-based flux-cored wire excellent in the low-temperature toughness of the weld metal up to the present. For example, JP-A-9-262693 discloses that contents of TiO₂, Mg, B, Ti, Mn, K, Na, and Si in a flux-cored wire are regulated to obtain good welding workability and excellent low-temperature toughness of a weld metal. However, the technique disclosed in JP-A-9-262693 does not regulate metal oxides other than TiO₂. This results in poor arc stability, slag encapsulation, and metal sagging resistance and therefore fails to obtain the sufficient welding workability.

JP-A-6-238483 discloses that a content of one kind or two kinds or more of TiO₂, SiO₂, Si, Mn, Mg, B, Al, Ca and Ni, Ti, Zr in a flux-cored wire is regulated to obtain good welding workability and excellent low-temperature toughness of a weld metal. According to this technique disclosed in JP-A-6-238483, additions of appropriate amounts of TiO₂ and SiO₂ can improve a welding workability such as a bead shape and slag encapsulation and improve low-temperature toughness of the weld metal brought by a combined effect of Ca, Al, Ti, and B. However, the technique disclosed in JP-A-6-238483 is inferior in arc stability and slag removability, failing to obtain sufficient welding workability.

JP-A-2016-203179 discloses that contents of, for example, C, Si, Mn, Ni, Al, B, TiO₂, Al₂O₃, SiO₂, ZrO₂, Mg, Na₂O, and K₂O in a flux-cored wire are regulated to obtain good welding workability and excellent low-temperature toughness of a weld metal. According to this technique disclosed in JP-A-2016-203179, additions of appropriate amounts of metal oxides such as TiO₂, Al₂O₃, SiO₂, ZrO₂, Mg, Na₂O, and K₂O provides good welding workability such as excellent bead shape, slag removability, and arc stability. Additionally, additions of appropriate amounts of C, Si, Mn, Ni, and B allow improvement in the low-temperature toughness of the weld metal. However, since the technique disclosed in JP-A-2016-203179 does not regulate the content of C in a skin made of steel; therefore, when the large amount of C is added from the skin made of steel, an arc becomes excessively sharp and an amount of generated spatter increases. The technique disclosed in JP-A-2016-203179 is likely to generate a metal sagging by vertical upward welding and the bead shape becomes poor, thereby failing to obtain the sufficient welding workability. Additionally, the technique disclosed in JP-A-2016-203179 does not regulate a fluorine compound and therefore the arc becomes weak. Accordingly, this causes a problem that the metal sagging is likely to occur in the vertical upward welding and a vertical downward welding and the bead shape is likely to become poor.

Therefore, the present invention has been invented in consideration of the above-described problems. An object of the present invention is to provide the following flux-cored wire for gas shielded arc welding. When a steel structure such as a 490 MPa class high-tensile steel and a low-temperature steel is welded from a mild steel, the flux-cored wire for gas shielded arc welding allows obtaining good welding workability in welding at all positions, a small amount of generated spatter, and excellent low-temperature toughness of a weld metal.

### SUMMARY

The inventors variously examined a flux-cored wire for gas shielded arc welding to obtain good welding workability in welding at all positions such as good arc stability and a small amount of generated spatter and good low-temperature toughness of a weld metal.

Consequently, the inventors have found that additions of appropriate amounts of Si and B in the flux-cored wire can improve the low-temperature toughness of the weld metal while securing a sufficient strength of the weld metal by additions of appropriate amounts of C and Mn. The inventors have also found that an addition of an appropriate amount of Ni or Ti can further improve the low-temperature toughness of the weld metal.

Regarding the welding workability, the inventors adjusted flux-cored wire constituents featuring good arc stability and a small amount of generated spatter. Consequently, the inventors have found that limiting a content of C in a skin made of steel of the flux-cored wire in an optimal range can improve the arc stability and the decrease in the amount of generated spatter by fining a droplet size. Furthermore, the inventors have found that additions of appropriate amounts of a Na compound and a K compound improve the arc stability.

Moreover, the inventors have found that additions of appropriate amounts of a Ti oxide, a Si oxide, a Zr oxide, Al and an Al oxide, Mg, and a fluorine compound in the flux-cored wire can improve a bead shape, a slag encapsulation, a slag removability, and a metal sagging resistance, providing good welding workability. The inventors have found that an addition of an appropriate amount of Bi can further improve the slag removability.

That is, the gist of the present invention is a flux-cored wire for gas shielded arc welding manufactured by filling a skin made of steel with a flux. The flux-cored wire for gas shielded arc welding contains C in the skin made of steel of 0.04 to 0.08% by mass % with respect to a total mass of the skin made of steel; by mass % with respect to a total mass of the wire by a sum of the skin made of steel and the flux: C: 0.05 to 0.12%; Si: 0.1 to 0.6%; Mn: 1.5 to 3.5%; B: 0.002 to 0.015%; and a sum of an Al₂O₃ conversion value of Al and an Al₂O₃ conversion value of an Al oxide: 0.3 to 1.5%; and further, by mass % with respect to the total mass of the wire in the flux: a sum of a TiO₂ conversion value of a Ti oxide: 5 to 10%; a sum of a SiO₂ conversion value of a Si oxide: 0.2 to 0.7%; a sum of a ZrO₂ conversion value of a Zr oxide: 0.1 to 0.6%; Mg: 0.2 to 0.8%; a sum of a F conversion value of a fluorine compound: 0.02 to 0.15%; and a sum of a Na₂O conversion value and a K₂O conversion value of a Na compound and a K compound: 0.03 to 0.20%. A balance is Fe in the skin made of steel, a Fe content in an iron powder, a Fe content in an iron alloy powder, and unavoidable impurities.

Furthermore, the flux-cored wire for gas shielded arc welding further contains one kind or two kinds of Ni: 0.1 to 0.6% and Ti: 0.05 to 0.50% by the sum of the skin made of steel and the flux by mass % with respect to the total mass of the wire.

Furthermore, the flux-cored wire for gas shielded arc welding further contains Bi: 0.005 to 0.020% in the flux by mass % with respect to the total mass of the wire.

When a steel structure such as a 490 MPa class high-tensile steel and a low-temperature steel is welded from a mild steel, the flux-cored wire for gas shielded arc welding to which the present invention is applied can obtain the good welding workability in welding at all positions, reduce the amount of generated spatter, and obtain the excellent low-temperature toughness of the weld metal; therefore, welding efficiency can be improved and a quality of a welded portion can be improved.

### DETAILED DESCRIPTION

The following describes component compositions and contents of the component compositions of a skin made of steel of a flux-cored wire for gas shielded arc welding to which the present invention is applied and reasons for limiting the respective component compositions. The contents of the component compositions are expressed by mass %, and the mass % is simply described as %.

[C in Skin Made of Steel: 0.04 to 0.08% by Mass % with Respect to the Total Mass of the Skin Made of Steel]

C in the skin made of steel has an effect of stabilization of an arc and grain refining of a droplet. C in the skin made of steel of less than 0.04% destabilizes the arc, makes the grain refining of the droplet difficult, and increases an amount of generated spatter. Meanwhile, C in the skin made of steel in excess of 0.08% excessively raises the arc and increases the amount of generated spatter and an amount of generated fume. A metal sagging is likely to occur in a vertical upward welding, resulting in poor bead shape. Accordingly, C in the skin made of steel is designed to be 0.04 to 0.08% by mass % with respect to the total mass of the skin made of steel.

The following expresses the contents of the respective component compositions by mass % with respect to the total mass of the flux-cored wire.

### [C by the Sum of the Skin Made of Steel and a Flux: 0.05 to 0.12%]

C has an effect of improving a strength of a weld metal. C of less than 0.05% fails to obtain the sufficient strength of the weld metal. Meanwhile, C in excess of 0.12% causes C to excessively yield in the weld metal and excessively enhances the strength of the weld metal, resulting in deterioration of low temperature toughness. Accordingly, C by the sum of the skin made of steel and the flux is designed to be 0.05 to 0.12%. In addition to the constituents contained in the skin made of steel, C can be added from, for example, metal powders and alloy powders in the flux.

### [Si by the Sum of the Skin Made of Steel and the Flux: 0.1 to 0.6%]

Si acts as a deoxidizer and has an effect of improving the low-temperature toughness of the weld metal. Si of less than 0.1% fails to obtain the effect and deteriorates the low-temperature toughness of the weld metal. Meanwhile, Si in excess of 0.6% increases an amount of slag generated during the welding and causes a slag inclusion. Additionally, Si excessively yields in the weld metal and the low temperature toughness of the weld metal is adversely deteriorated. Accordingly, Si by the sum of the skin made of steel and the flux is designed to be 0.1 to 0.6%. In addition to the constituents contained in the skin made of steel, Si can be added from the alloy powder such as metal Si, Fe—Si, and Fe—Si—Mn in the flux.

### [Mn by the Sum of the Skin Made of Steel and the Flux: 1.5 to 3.5%]

Mn acts as a deoxidizer and yields in the weld metal to provide effects of improving the strength and the low temperature toughness of the weld metal. Mn of less than 1.5% fails to cause Mn to sufficiently yield in the weld metal. This deteriorates the low-temperature toughness of the weld metal and fails to obtain the sufficient strength. Meanwhile, Mn in excess of 3.5% causes Mn to excessively yield in the weld metal. This increases the strength of the weld metal and deteriorates the low temperature toughness. Accordingly, Mn is designed to be 1.5 to 3.5% by the sum of the skin made of steel and the flux. In addition to the constituents contained in the skin made of steel, Mn can be added from the alloy powder such as metal Mn, Fe—Mn, and Fe—Si—Mn in the flux.

### [B by the Sum of the Skin Made of Steel and the Flux: 0.002 to 0.015%]

An addition of a trace of B brings an effect of miniaturizing a structure of the weld metal and improving the low temperature toughness of the weld metal. B of less than 0.002% fails to sufficiently obtain the effect and deteriorates the low-temperature toughness of the weld metal. Meanwhile, B in excess of 0.015% is likely to cause a hot crack. Accordingly, B is designed to be 0.002 to 0.015% by the sum of the skin made of steel and the flux. In addition to the constituents contained in the skin made of steel, B can be added from alloy powder such as metal B, Fe—B, and Fe—Mn—B in the flux.

[Sum of an Al₂O₃ Conversion Value of Al and an Al₂O₃ Conversion Value of Al Oxide by the Sum of the Skin Made of Steel and the Flux: 0.3 to 1.5%]

Al and the Al oxide have an effect of adjusting a melting point and viscosity of a molten slag during welding and especially improving a metal sagging resistance and a bead shape in the vertical upward welding. The sum of the Al₂O₃ conversion value of Al and the Al₂O₃ conversion value of the Al oxide of less than 0.3% fails to sufficiently obtain the effect. Further, the metal sagging is likely to occur in the vertical upward welding, and the bead shape becomes poor. Meanwhile, the sum of the Al₂O₃ conversion value of Al and the Al₂O₃ conversion value of Al oxide in excess of 1.5% causes the Al oxide to excessively remain in the weld metal, deteriorating the low-temperature toughness of the weld metal. Accordingly, the sum of the Al₂O₃ conversion value of Al and the Al₂O₃ conversion value of Al oxide is designed to be 0.3 to 1.5% by the sum of the skin made of steel and the flux. In addition to the constituents contained in the skin made of steel, Al can be added from the alloy powder such as metal Al and Fe—Al in the flux and the Al oxide can be added from, for example, alumina and potassium feldspar in the flux.

### [Sum of a TiO₂ Conversion Value of Ti Oxide in the Flux: 5 to 10%]

The Ti oxide is a main component of the slag and has an effect that adjusts the melting point and the viscosity of the molten slag during welding and improves the metal sagging resistance, a slag encapsulation, a slag removability, and the bead shape. The sum of the TiO₂ conversion value of the Ti oxide of less than 5% results in a small amount of generated slag, thereby resulting in poor slag encapsulation, slag removability, and bead shape in each posture welding. Additionally, the metal sagging is likely to occur in the vertical upward welding and a vertical downward welding. Meanwhile, the sum of the TiO₂ conversion value of the Ti oxide in excess of 10% increases the amount of generated slag too much and a weld defect such as the slag inclusion is likely to occur in a welded portion in each posture welding. Further, the Ti oxide excessively remains in the weld metal, deteriorating the low temperature toughness of the weld metal. Accordingly, the sum of the TiO₂ conversion value of the Ti oxide in the flux is designed to 5 to 10%. The Ti oxide is added from, for example, rutile, titanium oxide, titanium slag, and ilmenite in the flux.

### [Sum of a SiO₂ Conversion Value of Si Oxide in the Flux: 0.2 to 0.7%]

The Si oxide has an effect of adjusting the viscosity and the melting point of the molten slag during welding and improving the slag encapsulation. The sum of the SiO₂ conversion value of the Si oxide of less than 0.2% fails to sufficiently obtain this effect, worsens the slag encapsulation in each posture welding, and produces the poor bead shape. Meanwhile, the sum of the SiO₂ conversion value of the Si oxide in excess of 0.7% causes the Si oxide to excessively remain in the weld metal, deteriorates a basicity of the molten slag, increases an amount of oxygen in the weld metal, and deteriorates the low-temperature toughness of the weld metal. Accordingly, the sum of the SiO₂ conversion value of the Si oxide in the flux is designed to be 0.2 to 0.7%. The Si oxide can be added from, for example, silica sand, potassium feldspar, zircon sand, and sodium silicate in the flux.

### [Sum of a ZrO₂ Conversion Value of Zr Oxide in the Flux: 0.1 to 0.6%]

The Zr oxide has an effect of adjusting the melting point and the viscosity of the molten slag during welding and especially improving the metal sagging resistance and the bead shape in the vertical upward welding. The ZrO₂ conversion value of the Zr oxide of less than 0.1% fails to sufficiently obtain this effect. Further, the metal sagging is likely to occur in the vertical upward welding, and the bead shape becomes poor. Meanwhile, the ZrO₂ conversion value of the Zr oxide in excess of 0.6% results in a poor slag removability in each posture welding. Accordingly, the sum of the ZrO₂ conversion value of the Zr oxide in the flux is designed to be 0.1 to 0.6%. The Zr oxide can be added from, for example, zircon sand and zirconium oxide in the flux, and the trace of the Zr oxide is contained in the Ti oxide.

### [Mg in the Flux: 0.2 to 0.8%]

Mg acts as a strong deoxidizer and has an effect of reducing the oxygen in the weld metal and improving the low temperature toughness of the weld metal. Mg of less than 0.2% fails to sufficiently obtain this effect, causes a shortage of deoxidation, and deteriorates the low temperature toughness of the weld metal. Meanwhile, Mg in excess of 0.8% heavily reacts with the oxygen in the arc during welding and makes the arc unstable. Moreover, the amount of generated spatter increases and many spatters attach to a surface of a steel plate near a welding bead. Accordingly, Mg in the flux is designed to be 0.2 to 0.8%. Mg can be added from the alloy powder such as metal Mg and Al—Mg in the flux.

### [Sum of an F Conversion Value of the Fluorine Compound in the Flux: 0.02 to 0.15%]

The fluorine compound has an effect of raising the arc and especially improving the metal sagging resistance and the bead shape in the vertical upward welding and the vertical downward welding. The sum of the F conversion value of the fluorine compound of less than 0.02% fails to sufficiently obtain this effect and diminishes the arc. Moreover, the metal sagging is likely to occur in the vertical upward welding and the vertical downward welding, resulting in the poor bead shape. Meanwhile, the sum of the F conversion value of the fluorine compound in excess of 0.15% excessively raises the arc, and the metal sagging is likely to occur in the vertical upward welding, resulting in the poor bead shape. Accordingly, the sum of the F conversion value of the fluorine compound in the flux is designed to be 0.02 to 0.15%. The fluorine compound can be added from, for example, CaF₂, NaF, LiF, MgF₂, K₂SiF₆, Na₃AlF₆, and AlF₃, and the F conversion value is a sum of an amount of F contained in these components.

[Sum of a Na₂O Conversion Value and a K₂O Conversion Value of a Na Compound and a K Compound in the Flux: 0.03 to 0.20%]

The Na compound and the K compound act as an arc stabilizer and have an effect of improving the arc stability. The sum of the Na₂O conversion value and the K₂O conversion value of the Na compound and the K compound of less than 0.03% makes the arc unstable and increases the amount of generated spatter. Meanwhile, the sum of the Na₂O conversion value and the K₂O conversion value of the Na compound and the K compound in excess of 0.20% lengthens the arc length and destabilizes the arc and increases the amount of generated spatter and the amount of generated fume. Additionally, the metal sagging is less likely to occur in the vertical upward welding and the vertical downward welding, resulting in the poor bead shape. Accordingly, the sum of the Na₂O conversion value and the K₂O conversion value of the Na compound and the K compound in the flux is designed to be 0.03 to 0.20%. The Na compound and the K compound can be added from, for example, a solid component of water glass made of sodium silicate and potassium silicate, sodium fluoride, sodium titanate, potassium silicofluoride, and sodium silicofluoride.

### [Ni by the Sum of the Skin Made of Steel and the Flux: 0.1 to 0.6%]

Ni has an effect of further improving the low temperature toughness of the weld metal. Ni of less than 0.1% fails to sufficiently obtain the effect of further improving the low temperature toughness of the weld metal. Meanwhile, Ni in excess of 0.6% possibly excessively increases a tensile strength of the weld metal and a hot crack is likely to occur. Accordingly, Ni by the sum of the skin made of steel and the flux is designed to be 0.1 to 0.6%. In addition to the constituents contained in the skin made of steel, Ni can be added from the alloy powder such as metal Ni and Fe—Ni in the flux.

### [Ti by the Sum of the Skin Made of Steel and the Flux: 0.05 to 0.50%]

Ti has an effect of miniaturizing the structure of the weld metal and improving the low-temperature toughness. Ti of less than 0.05% fails to sufficiently obtain the effect of further improving the low-temperature toughness of the weld metal. Meanwhile, Ti in excess of 0.50% generates an upper bainite structure inhibiting the toughness and deteriorates the low-temperature toughness of the weld metal. Accordingly, Ti is designed to be 0.05 to 0.50% by the sum of the skin made of steel and the flux. In addition to the constituents contained in the skin made of steel, Ti can be added from the alloy powder such as metal Ti and Fe—Ti in the flux.

### [Bi by the Sum of the Skin Made of Steel and the Flux: 0.005 to 0.020%]

Bi has an effect of promoting a remove of the slag from the weld metal and further improving the slag removability. Bi of less than 0.005% fails to sufficiently obtain this effect and possibly fails to obtain the sufficient slag removability in welding at all positions. Meanwhile, Bi in excess of 0.020% deteriorates the low-temperature toughness of the weld metal. Additionally, the hot crack is likely to occur. Accordingly, Bi by the sum of the skin made of steel and the flux is designed to be 0.005 to 0.020%. Bi can be added from the alloy powder such as metal Bi in the flux.

The balance of the flux-cored wire for gas shielded arc welding of the present invention is Fe in the skin made of steel, an Fe content in iron powder to be added, an Fe content in iron alloy powder such as Fe—Mn and Fe—Si alloy, and the unavoidable impurities. For adjustment of the constituents, for example, FeO and MnO may be added. Although the unavoidable impurities are not especially limited, from an aspect of a hot crack resistance, P of 0.020% or less and S of 0.010% or less are preferred.

The iron powder is iron powder added to adjust the constituents. Since this iron powder is iron, it is apparent that the Fe content is contained. While C is added from, for example, the metal powder and the alloy powder in the flux, these metal powder and alloy powder are different from the iron powder purposely added to adjust the constituents. Accordingly, C is not contained in the iron powder in principle. Conversely, the content of C is not affected by the iron powder regardless of the amount of the iron powder. The same applies to other constituents such as Mn and Si.

The flux-cored wire for gas shielded arc welding of the present invention has a structure where the skin made of steel is formed into a pipe shape inside of which is filled with the flux and can be roughly divided into a seamless type manufactured by welding a joint of the skin made of steel and a type with a seam manufactured by swaging the joint of the skin made of steel without welding. The seamless type allows a heat treatment aiming to reduce an amount of hydrogen in the flux-cored wire. Additionally, a moisture absorption of the flux-cored wire after manufacturing is small; therefore, diffusible hydrogen of the weld metal can be reduced and a crack resistance can be improved, and therefore the seamless type is more preferable.

Although a filling rate of the flux is not especially limited, from an aspect of productivity, the filling rate is preferably 8 to 20% with respect to the total mass of the wire.

### Working Example

The following further specifically describes the effects of invention through the working examples.

Using JIS G 3141 SPCC of various component compositions shown in Table 1 for a skin made of steel, this skin made of steel was molded in a U-shaped mold, a flux was filled with a filling rate of 10 to 16%, and the flux was molded in a C-shaped mold. After that, a joint of the skin made of steel was welded to produce a pipe, and then a wire drawing was performed on the pipe to prototype flux-cored wires of various constituents shown in Table 2 and Table 3. The prototyped wire diameters were configured to be 1.2 mm

TABLE 1

| Sign of skin | Chemical composition (mass %) | | | | | |
|---|---|---|---|---|---|---|
| made of steel | C | Si | Mn | P | S | Al |
| S1 | 0.02 | 0.01 | 0.43 | 0.017 | 0.007 | 0.03 |
| S2 | 0.04 | 0.02 | 0.27 | 0.014 | 0.008 | 0.01 |
| S3 | 0.06 | 0.03 | 0.36 | 0.012 | 0.004 | 0.02 |
| S4 | 0.05 | 0.02 | 0.31 | 0.011 | 0.005 | 0.03 |
| S5 | 0.08 | 0.01 | 0.29 | 0.014 | 0.006 | 0.04 |
| S6 | 0.09 | 0.04 | 0.14 | 0.012 | 0.005 | 0.03 |

TABLE 2

| | | | Flux-cored wire constituent (mass % with respect to total mass of flux-cored wire) | | | | | | | | |
|---|---|---|---|---|---|---|---|---|---|---|---|
| | | | | | | | | (a) Al₂O₃ | (b) Al₂O₃ | | TiO₂ |
| | Wire | Sign of skin | | | | | | conversion value | conversion value | | conversion |
| Classification | sign | made of steel | C | Si | Mn | B | Al | of Al | of Al oxide | (a) + (b) | value |
| Present | W1 | S2 | 0.05 | 0.22 | 2.27 | 0.003 | 0.10 | 0.21 | 0.21 | 0.42 | 6.21 |
| invention | W2 | S3 | 0.12 | 0.30 | 2.06 | 0.011 | 0.05 | 0.13 | 0.74 | 0.87 | 9.33 |
| | W3 | S4 | 0.06 | 0.11 | 2.91 | 0.007 | 0.02 | 0.09 | 0.26 | 0.35 | 5.84 |
| | W4 | S2 | 0.07 | 0.58 | 2.67 | 0.008 | 0.24 | 0.47 | 0.97 | 1.44 | 7.72 |
| | W5 | S4 | 0.09 | 0.44 | 1.51 | 0.003 | 0.31 | 0.64 | 0.51 | 1.15 | 6.40 |
| | W6 | S2 | 0.05 | 0.12 | 3.48 | 0.002 | 0.18 | 0.34 | 0.08 | 0.42 | 8.22 |
| | W7 | S4 | 0.06 | 0.36 | 2.11 | 0.015 | 0.06 | 0.17 | 0.14 | 0.31 | 7.10 |
| | W8 | S2 | 0.06 | 0.50 | 1.67 | 0.004 | 0.51 | 0.98 | 0.50 | 1.48 | 8.64 |
| | W9 | S3 | 0.05 | 0.27 | 3.16 | 0.006 | 0.06 | 0.15 | 0.57 | 0.72 | 5.01 |
| | W10 | S4 | 0.05 | 0.42 | 2.31 | 0.009 | 0.20 | 0.43 | 1.00 | 1.43 | 9.97 |
| | W11 | S2 | 0.08 | 0.30 | 2.07 | 0.008 | 0.04 | 0.09 | 1.00 | 1.09 | 6.01 |
| | W12 | S3 | 0.06 | 0.53 | 1.86 | 0.007 | 0.21 | 0.43 | 0.40 | 0.83 | 6.44 |
| | W13 | S5 | 0.08 | 0.40 | 2.29 | 0.006 | 0.16 | 0.38 | 0.89 | 1.27 | 8.77 |
| | W14 | S4 | 0.05 | 0.15 | 3.04 | 0.005 | 0.10 | 0.25 | 0.74 | 0.99 | 8.94 |
| | W15 | S3 | 0.07 | 0.43 | 2.46 | 0.003 | 0.44 | 0.87 | 0.33 | 1.20 | 7.32 |
| | W16 | S2 | 0.06 | 0.22 | 1.87 | 0.004 | 0.36 | 0.70 | 0.23 | 0.93 | 6.34 |
| | W17 | S5 | 0.11 | 0.41 | 2.29 | 0.006 | 0.15 | 0.36 | 0.21 | 0.57 | 7.02 |
| | W18 | S4 | 0.05 | 0.52 | 2.71 | 0.008 | 0.70 | 1.38 | 0.06 | 1.44 | 5.83 |
| | W19 | S3 | 0.08 | 0.43 | 2.06 | 0.004 | 0.49 | 0.96 | 0.21 | 1.17 | 8.11 |
| | W20 | S2 | 0.09 | 0.32 | 1.47 | 0.003 | 0.50 | 0.96 | 0.38 | 1.34 | 9.53 |

| | | Flux-cored wire constituent (mass % with respect to total mass of flux-cored wire) | | | | | | | | | | |
|---|---|---|---|---|---|---|---|---|---|---|---|---|
| | | SiO₂ | ZrO₂ | | F | (c) Na₂O | (d) K₂O | | | | | |
| | Wire | conversion | conversion | | conversion | conversion | conversion | | | | | |
| Classification | sign | value | value | Mg | value | value | value | (c) + (d) | Ni | Ti | Bi | Others* |
| Present | W1 | 0.67 | 0.40 | 0.20 | 0.08 | 0.09 | 0.05 | 0.14 | 0.13 | — | 0.013 | Balance |
| invention | W2 | 0.41 | 0.22 | 0.66 | 0.04 | 0.03 | 0.03 | 0.06 | — | — | — | Balance |
| | W3 | 0.22 | 0.55 | 0.74 | 0.06 | 0.04 | 0.05 | 0.09 | — | 0.05 | 0.006 | Balance |
| | W4 | 0.38 | 0.50 | 0.42 | 0.11 | 0.05 | 0.06 | 0.11 | 0.22 | 0.48 | — | Balance |
| | W5 | 0.51 | 0.41 | 0.33 | 0.12 | 0.09 | 0.09 | 0.18 | — | — | — | Balance |
| | W6 | 0.60 | 0.58 | 0.21 | 0.07 | 0.02 | 0.02 | 0.04 | — | — | 0.018 | Balance |
| | W7 | 0.63 | 0.52 | 0.51 | 0.05 | 0.1 | 0.05 | 0.15 | 0.10 | 0.24 | 0.011 | Balance |
| | W8 | 0.24 | 0.24 | 0.43 | 0.09 | 0.01 | 0.06 | 0.07 | 0.59 | — | — | Balance |
| | W9 | 0.37 | 0.50 | 0.78 | 0.04 | 0.04 | 0.08 | 0.12 | — | 0.15 | — | Balance |
| | W10 | 0.41 | 0.22 | 0.60 | 0.10 | 0.05 | 0.14 | 0.19 | 0.36 | — | — | Balance |
| | W11 | 0.20 | 0.34 | 0.49 | 0.12 | 0.01 | 0.02 | 0.03 | 0.44 | — | 0.017 | Balance |
| | W12 | 0.67 | 0.44 | 0.55 | 0.06 | 0.05 | 0.05 | 0.10 | — | 0.33 | — | Balance |
| | W13 | 0.41 | 0.12 | 0.67 | 0.14 | 0.08 | 0.08 | 0.16 | 0.25 | — | 0.019 | Balance |
| | W14 | 0.33 | 0.59 | 0.62 | 0.03 | 0.04 | 0.14 | 0.18 | — | — | 0.005 | Balance |
| | W15 | 0.52 | 0.43 | 0.20 | 0.09 | 0.02 | 0.09 | 0.11 | — | 0.21 | — | Balance |
| | W16 | 0.37 | 0.18 | 0.43 | 0.07 | 0.11 | 0.06 | 0.17 | — | — | — | Balance |
| | W17 | 0.66 | 0.52 | 0.33 | 0.12 | 0.06 | 0.02 | 0.08 | — | — | — | Balance |
| | W18 | 0.52 | 0.11 | 0.38 | 0.06 | 0.10 | 0.05 | 0.15 | — | — | 0.015 | Balance |
| | W19 | 0.63 | 0.56 | 0.51 | 0.03 | 0.03 | 0.03 | 0.06 | 0.18 | 0.22 | — | Balance |
| | W20 | 0.40 | 0.57 | 0.40 | 0.14 | 0.11 | 0.02 | 0.13 | — | — | 0.009 | Balance |

*The others are FeO, MnO, Fe in the skin made of steel, the Fe content in the iron powder, the Fe content in the iron alloy powder, and the unavoidable impurities.

TABLE 3

| | | | Flux-cored wire constituent (mass % with respect to total mass of flux-cored wire) | | | | | | | | |
|---|---|---|---|---|---|---|---|---|---|---|---|
| | | | | | | | | (a) Al₂O₃ | (b) Al₂O₃ | | TiO₂ |
| | Wire | Sign of skin | | | | | | conversion value | conversion value | | conversion |
| Classification | sign | made of steel | C | Si | Mn | B | Al | of Al | of Al oxide | (a) + (b) | value |
| Comparative | W21 | S1 | 0.06 | 0.57 | 1.68 | 0.002 | 0.70 | 1.38 | 0.06 | 1.44 | 9.42 |
| example | W22 | S6 | 0.11 | 0.71 | 2.00 | 0.004 | 0.65 | 1.28 | 0.10 | 1.38 | 7.10 |
| | W23 | S2 | 0.04 | 0.36 | 1.54 | 0.012 | 0.24 | 0.47 | 0.14 | 0.61 | 5.33 |
| | W24 | S4 | 0.13 | 0.38 | 2.75 | 0.008 | 0.27 | 0.57 | 0.46 | 1.03 | 8.24 |
| | W25 | S2 | 0.08 | 0.03 | 1.85 | 0.010 | 0.11 | 0.23 | 0.55 | 0.78 | 7.01 |
| | W26 | S4 | 0.06 | 0.18 | 1.41 | 0.012 | 0.05 | 0.15 | 0.06 | 0.21 | 6.24 |
| | W27 | S3 | 0.07 | 0.27 | 3.62 | 0.009 | 0.46 | 0.91 | 0.43 | 1.34 | 5.28 |
| | W28 | S5 | 0.10 | 0.22 | 2.17 | 0.001 | 0.25 | 0.55 | 0.30 | 0.85 | 9.41 |
| | W29 | S3 | 0.07 | 0.48 | 1.73 | 0.016 | 0.32 | 0.64 | 0.68 | 1.32 | 7.55 |
| | W30 | S2 | 0.07 | 0.41 | 3.21 | 0.007 | 0.76 | 1.45 | 0.11 | 1.56 | 6.24 |
| | W31 | S4 | 0.08 | 0.34 | 1.63 | 0.004 | 0.33 | 0.68 | 0.04 | 0.72 | 11.21 |
| | W32 | S2 | 0.06 | 0.53 | 2.53 | 0.003 | 0.18 | 0.36 | 0.44 | 0.80 | 8.36 |
| | W33 | S3 | 0.10 | 0.38 | 2.70 | 0.014 | 0.21 | 0.43 | 0.62 | 1.05 | 9.11 |
| | W34 | S5 | 0.11 | 0.13 | 2.34 | 0.011 | 0.64 | 1.28 | 0.08 | 1.36 | 4.32 |
| | W35 | S4 | 0.08 | 0.25 | 1.41 | 0.004 | 0.33 | 0.68 | 0.36 | 1.04 | 6.25 |

| | | Flux-cored wire constituent (mass % with respect to total mass of flux-cored wire) | | | | | | | | | | |
|---|---|---|---|---|---|---|---|---|---|---|---|---|
| | | SiO₂ | ZrO₂ | | F | (c) Na₂O | (d) K₂O | | | | | |
| | Wire | conversion | conversion | | conversion | conversion | conversion | | | | | |
| Classification | sign | value | value | Mg | value | value | value | (c) + (d) | Ni | Ti | Bi | Others* |
| Comparative | W21 | 0.52 | 0.50 | 0.32 | 0.03 | 0.02 | 0.02 | 0.04 | 0.27 | 0.55 | 0.006 | Balance |
| example | W22 | 0.41 | 0.44 | 0.46 | 0.14 | 0.04 | 0.13 | 0.17 | — | — | — | Balance |
| | W23 | 0.11 | 0.63 | 0.71 | 0.09 | 0.06 | 0.06 | 0.12 | — | 0.18 | 0.018 | Balance |
| | W24 | 0.62 | 0.71 | 0.56 | 0.06 | 0.01 | 0.05 | 0.06 | — | — | 0.004 | Balance |
| | W25 | 0.68 | 0.22 | 0.60 | 0.04 | 0.03 | 0.06 | 0.09 | 0.02 | — | 0.010 | Balance |
| | W26 | 0.50 | 0.34 | 0.43 | 0.05 | 0.04 | 0.06 | 0.10 | 0.23 | — | — | Balance |
| | W27 | 0.64 | 0.55 | 0.94 | 0.12 | 0.02 | 0.04 | 0.06 | — | — | — | Balance |
| | W28 | 0.42 | 0.42 | 0.31 | 0.16 | 0.03 | 0.04 | 0.07 | — | 0.03 | — | Balance |
| | W29 | 0.83 | 0.57 | 0.27 | 0.08 | 0.11 | 0.1 | 0.21 | 0.19 | 0.07 | 0.007 | Balance |
| | W30 | 0.69 | 0.51 | 0.46 | 0.10 | 0.02 | 0.12 | 0.14 | 0.71 | 0.16 | — | Balance |
| | W31 | 0.60 | 0.02 | 0.52 | 0.07 | 0.06 | 0.14 | 0.20 | 0.36 | 0.08 | — | Balance |
| | W32 | 0.44 | 0.48 | 0.13 | 0.10 | 0.01 | 0.01 | 0.02 | — | — | — | Balance |
| | W33 | 0.51 | 0.20 | 0.74 | 0.01 | 0.09 | 0.09 | 0.18 | — | — | 0.021 | Balance |
| | W34 | 0.63 | 0.50 | 0.66 | 0.12 | 0.10 | 0.06 | 0.16 | 0.22 | 0.10 | 0.003 | Balance |
| | W35 | 0.22 | 0.43 | 0.52 | 0.13 | 0.03 | 0.10 | 0.13 | 0.04 | — | — | Balance |

*The others are FeO, MnO, Fe in the skin made of steel, the Fe content in the iron powder, the Fe content in the iron alloy powder, and the unavoidable impurities.

Tables 2 and 3 also describe a content of Al as a basis for a conversion of an Al₂O₃ conversion value.

Using these prototype wires, a welding workability and a machine performance of deposited metals in a vertical upward welding, a vertical downward welding, and a horizontal fillet welding were examined.

The vertical upward welding, the vertical downward welding, and the horizontal fillet welding were performed on tested objects produced by assembling SM490B steel plates having a plate thickness of 16 mm compliant to JIS G 3106 into a T shape under welding conditions shown in Table 4. Then, an arc state, a spatter occurrence state, a slag encapsulation, a slag removability, a quality of a bead shape, and presence/absence of a metal sagging were examined by visual check for the welding workability. Additionally, a fracture surface was checked compliant to JIS Z 3181 to examine a weld defect such as a slag inclusion.

TABLE 4

| | | | Welding | Arc | Welding | |
|---|---|---|---|---|---|---|
| | | | current | voltage | speed | |
| Test item | Groove shape | Welding posture | (A) | (V) | (cm/min) | Shield gas |
| Welding workability evaluation | T-shaped fillet | Vertical upward | 180 to 220 | 21 to 25 | 10 to 20 | CO₂ 100% |
| | | Vertical downward | 250 to 270 | 25 to 30 | 50 to 70 | CO₂ 100% |
| | | Horizontal fillet | 260 to 280 | 29 to 31 | 40 to 60 | CO₂ 100% |
| Deposited metal test | Compliant to JIS Z 3111 | Flat | 270 | 31 | 30 | CO₂ 100% |

In the deposited metal test, using SM490B steel plates having a plate thickness of 20 mm compliant to JIS G 3106, welding was performed in compliance with JIS Z 3111, tensile specimens (AO size) and impact specimens (V-shaped notch specimens) were sampled from the centers in the plate thickness direction of the deposited metals, and a machine test was conducted. The tensile test was evaluated determining the tensile strength of 490 to 670 MPa as good. As the evaluation of the impact test, a Charpy impact test was conducted at −30° C., and an average of repetitive three absorbed energies of 47 J or more was determined as good. Then, the presence/absence of the hot crack was examined by visual check during the welding of a first layer. Table 5 and table 6 summarize these results.

TABLE 5

| | | Welding workability | | | | | | | | |
|---|---|---|---|---|---|---|---|---|---|---|
| | | | | | Vertical upward | | | | | Vertical |
| | | | | | | | Presence/ | | | downward |
| | | | | | Slag | | absence of | | | Slag |
| | Wire | | Amount of | Amount of | encapsu- | Slag | metal | Bead | Weld | encapsu- |
| Classification | sign | Arc stability | generated spatter | generated fume | lation | removability | sagging | shape | defect | lation |
| Examples of | W1 | Stable | Small | Small | Good | Extremely good | Absent | Good | Absent | Good |
| the percent | W2 | Stable | Small | Small | Good | Good | Absent | Good | Absent | Good |
| invention | W3 | Stable | Small | Small | Good | Extremely good | Absent | Good | Absent | Good |
| | W4 | Stable | Small | Small | Good | Good | Absent | Good | Absent | Good |
| | W5 | Stable | Small | Small | Good | Good | Absent | Good | Absent | Good |
| | W6 | Stable | Small | Small | Good | Extremely good | Absent | Good | Absent | Good |
| | W7 | Stable | Small | Small | Good | Extremely good | Absent | Good | Absent | Good |
| | W8 | Stable | Small | Small | Good | Good | Absent | Good | Absent | Good |
| | W9 | Stable | Small | Small | Good | Good | Absent | Good | Absent | Good |
| | W10 | Stable | Small | Small | Good | Good | Absent | Good | Absent | Good |
| | W11 | Stable | Small | Small | Good | Extremely good | Absent | Good | Absent | Good |
| | W12 | Stable | Small | Small | Good | Good | Absent | Good | Absent | Good |
| | W13 | Stable | Small | Small | Good | Extremely good | Absent | Good | Absent | Good |
| | W14 | Stable | Small | Small | Good | Extremely good | Absent | Good | Absent | Good |
| | W15 | Stable | Small | Small | Good | Good | Absent | Good | Absent | Good |
| | W16 | Stable | Small | Small | Good | Good | Absent | Good | Absent | Good |
| | W17 | Stable | Small | Small | Good | Good | Absent | Good | Absent | Good |
| | W18 | Stable | Small | Small | Good | Extremely good | Absent | Good | Absent | Good |
| | W19 | Stable | Small | Small | Good | Good | Absent | Good | Absent | Good |
| | W20 | Stable | Small | Small | Good | Extremely good | Absent | Good | Absent | Good |

Welding workability
Vertical downward

| | | |
|---|---|---|
| Presence/ | Horizontal fillet | Deposited metal |

| | | Slag | absence of | | | Slag | Slag | | | Presence/ | | vE- |
|---|---|---|---|---|---|---|---|---|---|---|---|---|
| | Wire | removabil- | metal | Bead | Weld | encapsu- | removabil- | Bead | Weld | absence of | TS | 30 |
| Classification | sign | ity | sagging | shape | defect | lation | ity | shape | defect | hot crack | (MPa) | (J) |
| Examples of | W1 | Extremely good | Absent | Good | Absent | Good | Extremely good | Good | Absent | Absent | 559 | 101 |
| the percent | W2 | Good | Absent | Good | Absent | Good | Good | Good | Absent | Absent | 595 | 66 |
| invention | W3 | Extremely good | Absent | Good | Absent | Good | Extremely good | Good | Absent | Absent | 641 | 80 |
| | W4 | Good | Absent | Good | Absent | Good | Good | Good | Absent | Absent | 643 | 110 |
| | W5 | Good | Absent | Good | Absent | Good | Good | Good | Absent | Absent | 514 | 52 |
| | W6 | Extremely good | Absent | Good | Absent | Good | Extremely good | Good | Absent | Absent | 665 | 64 |
| | W7 | Extremely good | Absent | Good | Absent | Good | Extremely good | Good | Absent | Absent | 559 | 99 |
| | W8 | Good | Absent | Good | Absent | Good | Good | Good | Absent | Absent | 527 | 94 |
| | W9 | Good | Absent | Good | Absent | Good | Good | Good | Absent | Absent | 666 | 88 |
| | W10 | Good | Absent | Good | Absent | Good | Good | Good | Absent | Absent | 582 | 77 |
| | W11 | Extremely good | Absent | Good | Absent | Good | Extremely good | Good | Absent | Absent | 571 | 102 |
| | W12 | Good | Absent | Good | Absent | Good | Good | Good | Absent | Absent | 532 | 89 |
| | W13 | Extremely good | Absent | Good | Absent | Good | Extremely good | Good | Absent | Absent | 597 | 74 |
| | W14 | Extremely good | Absent | Good | Absent | Good | Extremely good | Good | Absent | Absent | 648 | 63 |
| | W15 | Good | Absent | Good | Absent | Good | Good | Good | Absent | Absent | 606 | 78 |
| | W16 | Good | Absent | Good | Absent | Good | Good | Good | Absent | Absent | 517 | 50 |
| | W17 | Good | Absent | Good | Absent | Good | Good | Good | Absent | Absent | 615 | 55 |
| | W18 | Extremely good | Absent | Good | Absent | Good | Extremely good | Good | Absent | Absent | 624 | 77 |
| | W19 | Good | Absent | Good | Absent | Good | Good | Good | Absent | Absent | 572 | 84 |
| | W20 | Extremely good | Absent | Good | Absent | Good | Extremely good | Good | Absent | Absent | 505 | 68 |

TABLE 6

| | | Welding workability | | | | | | | | |
|---|---|---|---|---|---|---|---|---|---|---|
| | | | | | Vertical upward | | | | | Vertical |
| | | | | | | | Presence/ | | | downward |
| | | | | | Slag | | absence of | | | Slag |
| Classifi- | Wire | | Amount of | Amount of | encapsu- | Slag | metal | Bead | Weld | encapsu- |
| cation | sign | Arc stability | generated spatter | generated fume | lation | removability | sagging | shape | defect | lation |
| Comparative | W21 | Unstable | Large | Small | Good | Extremely good | Absent | Good | Absent | Good |
| example | W22 | Strong | Large | Large | Good | Good | Present | Poor | Slag | Good |
| | | | | | | | | | inclusion | |
| | W23 | Stable | Small | Small | Poor | Extremely good | Absent | Poor | Absent | Poor |
| | W24 | Stable | Small | Small | Good | Poor | Absent | Good | Absent | Good |
| | W25 | Stable | Small | Small | Good | Extremely good | Absent | Good | Absent | Good |
| | W26 | Stable | Small | Small | Good | Good | Present | Poor | Absent | Good |
| | W27 | Unstable | Large | Small | Good | Good | Absent | Good | Absent | Good |
| | W28 | Strong | Small | Small | Good | Good | Present | Poor | Absent | Good |
| | W29 | Unstable | Large | Large | Good | Extremely good | Present | Poor | Absent | Good |
| | W30 | Stable | Small | Small | Good | Good | Absent | Good | Absent | Good |
| | W31 | Stable | Small | Small | Good | Good | Present | Poor | Slag | Good |
| | | | | | | | | | inclusion | |
| | W32 | Unstable | Large | Small | Good | Good | Absent | Good | Absent | Good |
| | W33 | Weak | Small | Small | Good | Extremely good | Present | Poor | Absent | Good |
| | W34 | Stable | Small | Small | Poor | Poor | Present | Poor | Absent | Poor |
| | W35 | Stable | Small | Small | Good | Good | Absent | Good | Absent | Good |

| | | Welding workability | | | | | | | | | | |
|---|---|---|---|---|---|---|---|---|---|---|---|---|
| | | Vertical downward | | | | | | | | | | |
| | | | Presence/ | | | Horizontal fillet | | | | Deposited metal | | |
| | | Slag | absence of | | | Slag | Slag | | | Presence/ | | vE- |
| Classifi- | Wire | removabil- | metal | Bead | Weld | encapsu- | removabil- | Bead | Weld | absence of | TS | 30 |
| cation | sign | ity | sagging | shape | defect | lation | ity | shape | defect | hot crack | (MPa) | (J) |
| Comparative | W21 | Extremely good | Absent | Good | Absent | Good | Extremely good | Good | Absent | Absent | 516 | 33 |
| example | W22 | Good | Absent | Good | Slag | Good | Good | Good | Slag | Absent | 591 | 24 |
| | | | | | inclusion | | | | inclusion | | | |
| | W23 | Extremely good | Absent | Poor | Absent | Poor | Extremely good | Poor | Absent | Absent | 468 | 81 |
| | W24 | Poor | Absent | Good | Absent | Good | Poor | Good | Absent | Absent | 686 | 28 |
| | W25 | Extremely good | Absent | Good | Absent | Good | Extremely good | Good | Absent | Absent | 524 | 30 |
| | W26 | Good | Absent | Good | Absent | Good | Good | Good | Absent | Absent | 468 | 32 |
| | W27 | Good | Absent | Good | Absent | Good | Good | Good | Absent | Absent | 735 | 44 |
| | W28 | Good | Absent | Good | Absent | Good | Good | Good | Absent | Absent | 587 | 29 |
| | W29 | Extremely good | Present | Poor | Absent | Good | Extremely good | Good | Absent | Present | 528 | 21 |
| | W30 | Good | Absent | Good | Absent | Good | Good | Good | Absent | Present | 714 | 36 |
| | W31 | Good | Absent | Good | Slag | Good | Good | Good | Slag | Absent | 524 | 22 |
| | | | | | inclusion | | | | inclusion | | | |
| | W32 | Good | Absent | Good | Absent | Good | Good | Good | Absent | Absent | 612 | 39 |
| | W33 | Extremely good | Present | Poor | Absent | Good | Extremely good | Good | Absent | Absent | 655 | 64 |
| | W34 | Poor | Present | Poor | Absent | Poor | Poor | Poor | Absent | Absent | 619 | 76 |
| | W35 | Good | Absent | Good | Absent | Good | Good | Good | Absent | Absent | 481 | 40 |

Wire signs W1 to W20 in Table 2 and Table 5 are examples of the present invention and wire signs W21 to W35 in Table 3 and Table 6 are comparative examples. In W1 to W20, which are the examples of the present invention, C in the skin made of steel, C, Si, Mn, B, and the sum of the Al₂O₃ conversion value of Al and the Al₂O₃ conversion value of the Al oxide by the sum of the skin made of steel and the flux in the flux-cored wire, the sum of the TiO₂ conversion value of the Ti oxide, the sum of the SiO₂ conversion value of the Si oxide, the sum of the ZrO₂ conversion value of the Zr oxide, Mg, the sum of the F conversion value of the fluorine compound, and the sum of the Na₂O conversion value and the K₂O conversion value of the Na compound and the K compound in the flux were appropriate. Therefore, the arc was stable, the amount of generated spatter was small, the metal sagging did not occur in the vertical upward welding and the vertical downward welding, the slag encapsulation, the slag removability, and the bead shape were good in each posture welding, the weld defect such as the slag inclusion did not occur, the welding workability was good, and the hot crack did not occur. Additionally, the tensile strength and the absorbed energy of the deposited metal were also good.

Since the appropriate amount of Ni was added, the absorbed energies of the deposited metals with the wire signs W1, W4, W7, W8, W10, W11, W13, and W19 were 70 J or more. Since the appropriate amount of Ti was added, the absorbed energies of the deposited metals with the wire signs W3, W4, W7, W9, W12, W15, and W19 were 70 J or more. Since the appropriate amounts of Ni and Ti were added, the absorbed energies of the deposited metals with the wire signs W4, W7, and W19 were 70 J or more. Furthermore, since the appropriate amount of Bi was added, the slag removability of the wire signs W1, W3, W6, W7, W11, W13, W14, W18, and W20 was extremely good.

The wire sign W21 contained the small amount of C in the skin made of steel among the comparative examples; therefore, the arc was unstable and the amount of generated spatter was large. Since the amount of Ti in the flux was large, the absorbed energy of the deposited metal was low.

Since the wire sign W22 contained the large amount of C in the skin made of steel, the arc was excessively raised, and the amount of generated spatter and the amount of generated fume were large. The metal sagging occurred in the vertical upward welding, and the bead shape was poor. Since the amount of Si was large by the sum of the skin made of steel and the flux, the absorbed energy of the deposited metal was low, and the slag inclusion occurred in all welding postures.

Since the wire sign W23 contained the small amount of C by the sum of the skin made of steel and the flux, the tensile strength of the deposited metal was low. Since the sum of the SiO₂ conversion value of the Si oxide in the flux was small, the slag encapsulation and the bead shape were poor in all welding postures.

Since the wire sign W24 contained the large amount of C by the sum of the skin made of steel and the flux, the tensile strength of the deposited metal was high and the absorbed energy was low. Since the ZrO₂ conversion value of the Zr oxide in the flux was large, the slag removability was poor in all welding postures. Furthermore, since the amount of Bi in the flux was small, the effect of improving the slag removability was not able to be obtained.

Since the wire sign W25 contained the small amount of Si by the sum of the skin made of steel and the flux, the absorbed energy of the deposited metal was low. Further, since the amount of Ni was small by the sum of the skin made of steel and the flux, the effect of improving the absorbed energy of the deposited metal was not able to be obtained.

Since the wire sign W26 contained the small amount of Mn by the sum of the skin made of steel and the flux, the tensile strength and the absorbed energy of the deposited metal were low. Since the sum of the Al₂O₃ conversion value of Al and the Al₂O₃ conversion value of the Al oxide were small by the sum of the skin made of steel and the flux, the metal sagging occurred in the vertical upward welding and the bead shape was poor.

Since the wire sign W27 contained the large amount of Mn by the sum of the skin made of steel and the flux, the tensile strength of the deposited metal was high and the absorbed energy was low. Since the amount of Mg in the flux was large, the arc was unstable and the amount of generated spatter was large.

Since the wire sign W28 contained the small amount of B by the sum of the skin made of steel and the flux, the absorbed energy of the deposited metal was low. Since the amount of Ti was small by the sum of the skin made of steel and the flux, the effect of improving the absorbed energy of the deposited metal was not able to be obtained. Furthermore, since the sum of the F conversion value of the fluorine compound in the flux was large, the arc was excessively raised, the metal sagging occurred in the vertical upward welding, and the bead shape was poor.

Since the wire sign W29 contained the large amount of B by the sum of the skin made of steel and the flux, the hot crack occurred in the welded portion. Additionally, since the sum of the SiO₂ conversion value of the Si oxide in the flux was large, the absorbed energy of the deposited metal was low. Furthermore, since the sum of the Na₂O conversion value and the K₂O conversion value of the Na compound and the K compound in the flux were large, the arc was unstable, and the amount of generated spatter and the amount of generated fume were large. The metal sagging occurred in the vertical upward welding and the vertical downward welding, and the bead shape was poor.

Since the wire sign W30 had the large sum of the Al₂O₃ conversion value of Al and the Al₂O₃ conversion value of the Al oxide by the sum of the skin made of steel and the flux, the absorbed energy of the deposited metal was low. Further, since the amount of Ni was large by the sum of the skin made of steel and the flux, the tensile strength of the deposited metal was high and the hot crack occurred in the welded portion.

Since the wire sign W31 had the large sum of the TiO₂ conversion value of the Ti oxide in the flux, the absorbed energy of the deposited metal was low. Additionally, the slag inclusion occurred in all welding postures. Furthermore, since the sum of the ZrO₂ conversion value of the Zr oxide in the flux was small, the metal sagging occurred in the vertical upward welding, and the bead shape was poor.

Since the wire sign W32 had the small amount of Mg in the flux, the absorbed energy of the deposited metal was low. Since the sum of the Na₂O conversion value and the K₂O conversion value of the Na compound and the K compound in the flux was small, the arc was unstable, and the amount of generated spatter was large.

Since the wire sign W33 had the small sum of the F conversion value of the fluorine compound in the flux, the arc became weak, the metal sagging occurred in the vertical upward welding and the vertical downward welding, and the bead shape was poor.

Since the wire sign W34 had the small sum of the TiO₂ conversion value of the Ti oxide in the flux, the metal sagging occurred in the vertical upward welding and the vertical downward welding, and the slag encapsulation, the slag removability, and the bead shape were poor in all welding postures. Since the amount of Bi in the flux was small, the effect of improving the slag removability was not able to be obtained.

Since the wire sign W35 contained the small amount of Mn by the sum of the skin made of steel and the flux, the tensile strength of the deposited metal and the absorbed energy were low. Since the amount of Ni was small by the sum of the skin made of steel and the flux, the effect of improving the absorbed energy of the deposited metal was not able to be obtained.

What is claimed is:

1. A flux-cored wire for gas shielded arc welding manufactured by filling a skin made of steel with a flux, the flux-cored wire for gas shielded arc welding comprising:
C in the skin made of steel of 0.04 to 0.08% by mass % with respect to a total mass of the skin made of steel;
by mass % with respect to a total mass of the wire by a sum of the skin made of steel and the flux:
C: 0.05 to 0.12%;
Si: 0.1 to 0.6%;
Mn: 1.5 to 3.5%;
B: 0.002 to 0.015%; and
a sum of an Al₂O₃ conversion value of Al and an Al₂O₃ conversion value of an Al oxide: 0.3 to 1.5%; and
further, by mass % with respect to the total mass of the wire in the flux:
a sum of a TiO₂ conversion value of a Ti oxide: 5 to 10%;
a sum of a SiO₂ conversion value of a Si oxide: 0.2 to 0.7%;
a sum of a ZrO₂ conversion value of a Zr oxide: 0.1 to 0.6%;
Mg: 0.2 to 0.8%;
a sum of a F conversion value of a fluorine compound: 0.02 to 0.15%; and
a sum of a Na₂O conversion value and a K₂O conversion value of a Na compound and a K compound: 0.03 to 0.20%, wherein
a balance is Fe in the skin made of steel, a Fe content in an iron powder, a Fe content in an iron alloy powder, and unavoidable impurities.

2. The flux-cored wire for gas shielded arc welding according to claim 1, further comprising one kind or two kinds of Ni: 0.1 to 0.6% and Ti: 0.05 to 0.50% by the sum of the skin made of steel and the flux by mass % with respect to the total mass of the wire.

3. The flux-cored wire for gas shielded arc welding according to claim 1, further comprising Bi: 0.005 to 0.020% in the flux by mass % with respect to the total mass of the wire.

4. The flux-cored wire for gas shielded arc welding according to claim 2, further comprising Bi: 0.005 to 0.020% in the flux by mass % with respect to the total mass of the wire.
